(19) United States
(12) Patent Application Publication
(10) Pub. No.: US 2016/0127301 A1
(43) Pub. Date: May 5, 2016

(54) Messaging System for Determining Reliability of Push Messages

(71) Applicants: Young Min JEOUNG, Gimpo-si (KR); OPENVACS CO., LTD., Seoul (KR)

(72) Inventor: Young Min Jeoung, Gimpo-si (KR)

(73) Assignees: Young Min Jeoung, Gimpo-si (KR); Openvacs Co., Ltd., Seoul (KR)

(21) Appl. No.: 14/895,977

(22) PCT Filed: Jun. 3, 2014
(86) PCT No.: PCT/KR2014/004953

§ 371 Date: Dec. 4, 2015

(30) Foreign Application Priority Data
Jun. 7, 2013 (KR) 10-2013-0065433

(51) Int. Cl. H04L 12/58; H04W 4/14

(52) U.S. Cl. CPC H04L 51/30; H04W 4/14

(57) ABSTRACT

A method for controlling voice emoticons in a portable terminal for providing a recipient portable terminal with various voice files according to the emotions and feelings of the user in place of text-based emoticons, thereby enabling the various voice files to be played and to express rich emotions compared to the existing monotonous and dry TTS-based voice files. The method includes steps of: displaying a voice emoticon call menu for calling a voice emoticon menu on one area of a touch screen; displaying the voice emoticon menu provided with a voice emoticon list after the voice emoticon call menu is user-selected; and transmitting a voice emoticon user-selected from the voice emoticon list to a recipient portable terminal in place of the voice of the user.

### TECHNICAL FIELD

The present invention generally relates to a messaging system and, more particularly, to a messaging system for determining the reliability of a push message, which determines whether a message from a sender terminal to a recipient terminal has been sent, whether the message has arrived at the recipient terminal, and whether the message has been read, and which displays the results of the determination on the sender's portable terminal, thus determining the reliability of messages.

### BACKGROUND ART

When messages are exchanged using a portable terminal such as a mobile phone and a smart phone, a sender does not know whether the sent message has successfully arrived at a recipient and then the recipient has read the message. The sender can only send a message using his or her portable terminal and can recognize that the message has been successfully delivered and has been successfully received by the recipient only when the message has been read on the recipient's portable terminal.

From the standpoint of a recipient, the recipient suffers from a heavy increase in the number of unwanted messages, the non-existence of suitable replies to the contents of received messages, and the reception of spam messages. In relation to this problem, Korean Patent Application Publication No. 10-2007-0107378 proposes a method for providing an additional communication service for the protection of privacy, which receives only content transmitted from registered senders, and designates user-set reception methods for respective senders, thus protecting the recipient's privacy.

However, Korean Patent Application publication No. 10-2007-0107378 has been emphasized only from the standpoint of the protection of a recipient's privacy, but excludes the standpoint of a sender.

Typically, since a recipient terminal may recognize who sent a message when the message is received, the recipient may not read messages from unwanted senders, or may grasp the approximate content of a message received at the recipient terminal by applying a preview function to the received message. Accordingly, if the content of the message read using a preview function is a work-related instruction or an unwanted request, the recipient may not select the received message and may neglect it as if he or she could not read the message.

Accordingly, a sender who sends a message does not know whether the message sent to the recipient terminal has been successfully delivered, whether the message has successfully arrived at the recipient terminal after being sent, or whether the recipient has read the message, and thus may feel impatient. In relation to this problem, the present applicant intends to propose a messaging system for determining the reliability of push messages, which reduces misunderstanding and inconvenience attributable to the push messages by allowing a message sender to know the status of sent messages.

### DISCLOSURE

### Technical Problem

An object of the present invention is to provide a messaging system for determining the reliability of push messages, which notifies a sender of the status of a message that is sent from the sender to a recipient and enables the status of the message to be displayed on the terminal of the sender, thus reducing misunderstanding and inconvenience caused by the delivery of messages.

### Technical Solution

According to the present invention, the above object is accomplished by a messaging system for determining reliability of push messages, wherein the messaging system is configured to send a push message, corresponding to a message to be sent from a sender terminal to a recipient terminal, to the recipient terminal, send the push message to the recipient terminal, with content of the push message being private, determine status of a session with the recipient terminal, and send a control message to the sender terminal so that “message arrived” is displayed as status of the push message if the status of the session is a connected state and the push message has not yet been read on the recipient terminal, and send a control message to the sender terminal so that “message read” is displayed as the status of the push message if the push message has been read on the recipient terminal.

### Advantageous Effects

According to the present invention, whether a message sent from a sender terminal to a recipient terminal has been successfully delivered to the recipient terminal, whether the message has successfully arrived at the recipient terminal, and whether the message has been read at the recipient terminal may be clearly displayed on the sender terminal, thus preventing misunderstanding and inconvenience from occurring between the sender and the recipient in relation to the sending/receipt of messages.

### DESCRIPTION OF DRAWINGS

FIG. 1 is a conceptual diagram showing a messaging system for determining the reliability of push messages according to an embodiment of the present invention;

FIGS. 2 to 5 are reference diagrams showing the interface of an application being prepared for commercialization by the present applicant; and

FIG. 6 is a flowchart showing a method for determining the reliability of push messages in the messaging system according to an embodiment of the present invention.

### BEST MODE

The term “portable terminal” described in the present specification denotes a mobile phone, a smart phone, a Personal Digital Assistant (PDA), and other types of devices that enable voice communication and data communication using a Code Division Multiple Access (CDMA), Global System for Mobile communications (GSM), or Long Term Evolution (LTE) scheme and that include a touch screen. The portable terminal will be stated and described based on a structure equipped with a touch screen. Further, in the present specification, based on a message-sending side and a message-receiving side, portable terminals are described as a sender terminal and a recipient terminal.

The term ‘message’ described in the present specification refers to a message that is sent from a sender terminal to the messaging system for determining the reliability of push messages, and the term “push message” refers to a message that is sent from the messaging system for determining the reliability of push messages to a recipient terminal. In the present specification, “message” and “push message” may be used and described together for the convenience of description and understanding.

The expression “message arrived” for the status of a push message in the present specification may mean that the recipient terminal has successfully received the push message.

The expression “message read” for the status of a push message in the present specification means that the push message has been read on the recipient terminal.

Hereinafter, the present invention will be described in detail with reference to the attached drawings.

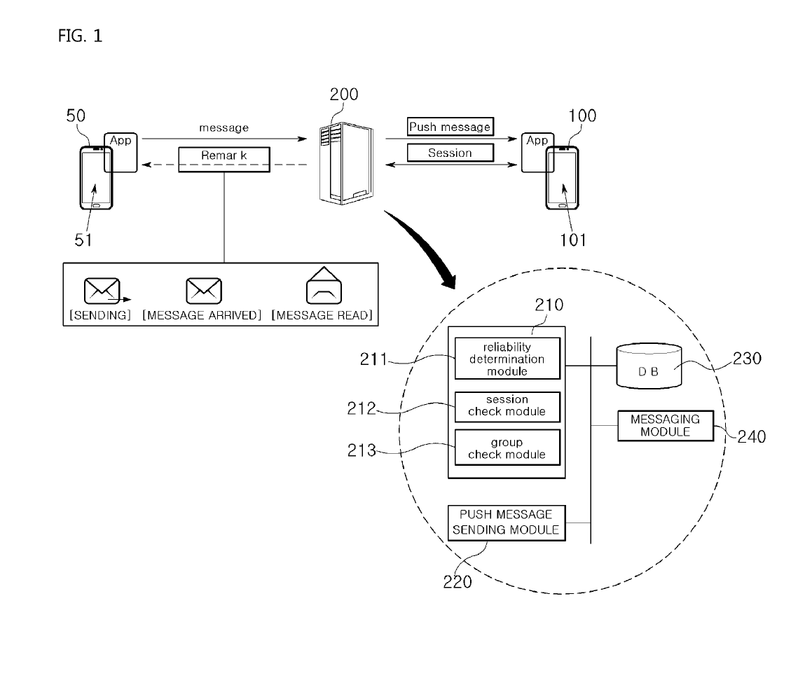

FIG. 1 is a conceptual diagram showing a messaging system for determining the reliability of push messages (hereinafter referred to as a “messaging system”) according to an embodiment of the present invention.

Referring to FIG. 1, a messaging system 200 according to an embodiment is connected to a sender terminal 50 and a recipient terminal 100 over a wireless network, and is configured to, when the sender terminal 50 sends a message, create a push message corresponding to the message and send the created push message to the recipient terminal 100. At this time, the messaging system 200 may determine two states for the push message depending on the status of a session with an application (app) on the recipient terminal 100. Here, the session may denote a session established with an application (app) installed on the sender terminal 50 and the recipient terminal 100.

1) When a push message is delivered to the recipient terminal 100 in the state in which the session is maintained, it may be determined that the push message has been delivered to the recipient terminal 100, and

2) when the session established with the app installed in the recipient terminal 100 is disconnected, it may be determined that a push message is being sent to the recipient terminal 100.

In addition, when the app notifies the recipient terminal 100 of the selection of the push message by a user while a session with the app is maintained, it may be determined that the push message has arrived at the recipient terminal 100.

That is, the message system 200 may determine the status of the push message corresponding to the message sent from the sender terminal 50 using the maintenance status of the session and the notification of the app installed on the recipient terminal 100.

Depending on the results of the determination, the messaging system 200 may send a control message to the sender terminal 50. The messaging system 200 allows the app running on the sender terminal 50 to divide the status of the push message into three states, that is, “sending”, “message arrived”, and “message read”, for the push message, and to separately display the states.

The expression “sending” denotes the state in which a push message is currently being sent from the messaging system 200 to the recipient terminal 100, and may mean one of the case where the recipient terminal 100 is in a power-off state and the case where the app is not running on the recipient terminal 100.

Further, the expression “message arrived” may refer to the case where a push message is sent while the recipient terminal 100 is running the app, or the case where a message sent from the messaging system 200 is displayed in the form of a message receipt alert (notification) on the recipient terminal 100 and then the recipient terminal 100 may recognize whether the message has arrived.

Further, the expression “message read” may denote the case where, when a push message is sent to the recipient terminal 100 in the state in which the recipient terminal 100 is in a power-on state and the app on the recipient terminal 100 is running, the content of the message is read on the recipient terminal 100.

As the above-described app, the same app may be installed both on the sender terminal 50 and on the recipient terminal 100, and may basically support a voice call between the sender terminal 50 and the recipient terminal 100 and may have a messaging function for sending/receiving messages therebetween, together with the voice call function. The app may perform the functions described in the following:

4) a function of displaying and executing a messaging interface for sending/receiving instant messages between the sender terminal 50 and the recipient terminal 100 on a touch screen,

5) a function of allowing the sender terminal 50 and the recipient terminal 100 to set groups with which instant messages are to be exchanged,

6) a function of allowing the users of the sender terminal 50 and the recipient terminal 100 to record their voices, generate voice talk files, and transmit the voice talk files to their counterpart terminals (sender terminal or recipient terminal), wherein the sender terminal 50 and the recipient terminal 100 alternately transmit and receive the voice talk files generated thereby, as in the case of a walkie-talkie, and

7) a function of displaying an interface that allows the user to use the functions in 4) to 6) on the sender terminal 50 or the recipient terminal 100.

Here, when the sender terminal 50 and the recipient terminal 100 belong to the same group, for example, when the sender terminal 50 and the recipient terminal 100 participate in the same group chat room, information about a push message corresponding to the message sent from the sender terminal 50 to the recipient terminal 100 may be open (public).

In an embodiment, for a push message, sender information is processed as closed (private) information, so that the recipient terminal 100 displays information about only the arrival of a message, such as “new message arrived”, and the recipient does not know who sent the corresponding message. By means of this function, the problem in that a recipient filters push messages from unwanted senders, leaves the push messages unread, or does not read the push messages may be solved.

However, when mutual instant messages are exchanged using a messaging function in the same group chat room, it is apparent that the users of the sender terminal 50 and the recipient terminal 100 are currently exchanging instant messages with each other, and a current state is not the state in which push messages cannot be received due to other tasks or schedules, and thus there is no need to hide sender information of the push messages.

In this case, sender information may be indicated in a push message that is sent from the sender terminal 50 to the recipient terminal 100, and the push message at this time may be understood to be an action of sending individual notes to a specific person of the users in the same group chat room.

Here, the sender information may be one of the name, contact, ID, and nickname of a sender, wherein the name of the sender may be arbitrarily set by the recipient terminal 100. For example, when the real name of the sender is “Hong Gil-dong”, and the sender is registered as “Gil-dong” on the recipient terminal 100, the sender information may be indicated by “Gil-dong” instead of “Hong Gil-dong”.

Preferably, the messaging system 200 may be configured to include a push message control module 210, a push message sending module 220, a database (DB) 230, and a messaging module 240.

When the sender terminal 50 requests the sending of a message to the recipient terminal 100, the push message control module 210 may request the push message sending module 220 to send a push message corresponding to the message, may determine whether to display sender information on the recipient terminal 100 with reference to the status of a session with the recipient terminal 100 and the status of group setting, upon sending the push message, and may send a control message for the push message to the sender terminal 50. The control message may mean a message enabling the status of the push message to be displayed on the interface of the app installed and running on the sender terminal 50. The control message enables three states, such as “sending”, “message arrived”, and “message read”, for a push message to be displayed in the form of text or an image on the app interface of the sender terminal 50.

Here, the control message may further include time information. For example, information about the time at which a push message arrived at the recipient terminal 100 and the time at which the user of the recipient terminal 100 read the push message may be included in the control message.

By means of the representation of time information, the user of the sender terminal 50 may know when the recipient received the sender's message and when the recipient read the received message. Since whether the message has arrived and has been read is definitely exposed to the sender, words and deeds that mutually cause unnecessary misunderstanding in relation to the sending/receipt of messages may be prevented.

The push message sending module 220 creates a push message for the message sent from the sender terminal 50, and sends the created push message to the recipient terminal 100. The push message is sent in one direction from the messaging system 200 to the recipient terminal 100. The app installed on the recipient terminal 100 may access the messaging system 200 at regular intervals (e.g. per 10 minutes), may check whether a push message has been sent, and may request and receive a push message from the messaging system 200 if there is a push message not received yet. Alternatively, the push message may be sent and received when the recipient terminal 50 is in the state in which it is capable of receiving the push message sent from the messaging system 200, for example, when the recipient terminal 50 is in a power-on state, or when the app installed on the recipient terminal 50 may run.

Therefore, even if the push message has been sent from the sender terminal 50 to the recipient terminal 100, it is not always delivered in real time, and a delivery delay may occur depending on a period at which the recipient terminal 100 accesses the messaging system 200 or the status of the recipient terminal 50. Here, the status of the recipient terminal 50 may denote the status of the recipient terminal depending on whether the recipient terminal 50 is powered on or whether the app is running. When the recipient terminal 50 is a power-off state, it is impossible to send a push message to the recipient terminal 50 in real time. Even if the app installed on the recipient terminal 50 is not in a running state, a push message may not be sent in real time.

The DB 230 includes information about the users of the sender terminal 50 and the recipient terminal 100 (sender information and recipient information). The DB 230 may include a new version of the app to provide the new version of the app to the sender terminal 50 and to the recipient terminal 100, and may include information about a group when the sender terminal 50 or the recipient terminal 100 sets the group. At this time, the group information may denote information about other parties with which instant messages are to be exchanged in a single chat room.

The messaging module 240 may support group chats for multiple users depending on the group information set in the DB 230, or may allow the sender terminal 50 and the recipient terminal 100 to exchange 1:1 instant messages with each other.

The push message control module 210 may include a reliability determination module 211, a session check module 212, and a group check module 213.

The session check module 212 may check the status of a session with the app installed on the sender terminal 50 and the recipient terminal 100.

The group check module 213 determines targets that are grouped to exchange instant messages through the messaging module 240. This is intended to, when the sender terminal 50 sends a message to the recipient terminal 100, determine whether a target to which a push message corresponding to the message is to be sent belongs to the same chat group. The reason for this is that, if the sender terminal 50 and the recipient terminal 100 participate in group chatting in the same group, information about the sender of a push message corresponding to the message that is sent from the sender terminal 50 to the recipient terminal 100 does not need to be processed as private information.

The reliability determination module 211 may determine the status of a push message corresponding to the message requested to be sent from the sender terminal 50 to the recipient terminal 100, based on the results of checking by the session check module 212 and the group check module 213, may create a control message based on the results of determination, and may provide the control message to the sender terminal 50. In response to the control message, the sender terminal 50 may detect the status of the message requested to be sent to the recipient terminal 100. At this time, on the touch screen of the sender terminal 50, the status of the message may be displayed in the form of text or an image. Further, the control message may include information about the time at which the sender's message arrived at the recipient terminal 100 and the time at which the sender's message was read on the recipient terminal 100.

Further, the control message may include information about the types of push messages. Such a push message may be a message corresponding to at least one of text, voice, picture, and image-based messages. Among these messages, the voice-based push message may correspond to a voice talk file proposed by the present applicant.

The term “voice talk file” denotes a file formed by recording the voice of the sender on the sender terminal 50, and may be used to perform voice communication while the sender terminal 50 and the recipient terminal 100 are alternately exchanging voice talk files. Each voice talk file enables voice signals to be stably transmitted and received without damaging the voice signals even if a Wi-Fi network and a 3G/4G data network are unstable when the sender terminal 50 and the recipient terminal 100 perform voice communication over the Wi-Fi network and the 3G/4G data network. The reason for this is to maintain the quality of voice signals by preventing the voice signals from being influenced by the status or quality of a communication network as long as a voice talk file itself is not damaged because the voice talk file includes voice signals and has the form of a file. The reliability determination module 211 determines the status of a push message desired to be sent from the sender terminal 50 to the recipient terminal 100 to be three states, such as “sending”, “message arrived”, and “message read”, and sends a control message corresponding to each determined state to the sender terminal 50 to allow the sender terminal 50 to determine the status of the message.

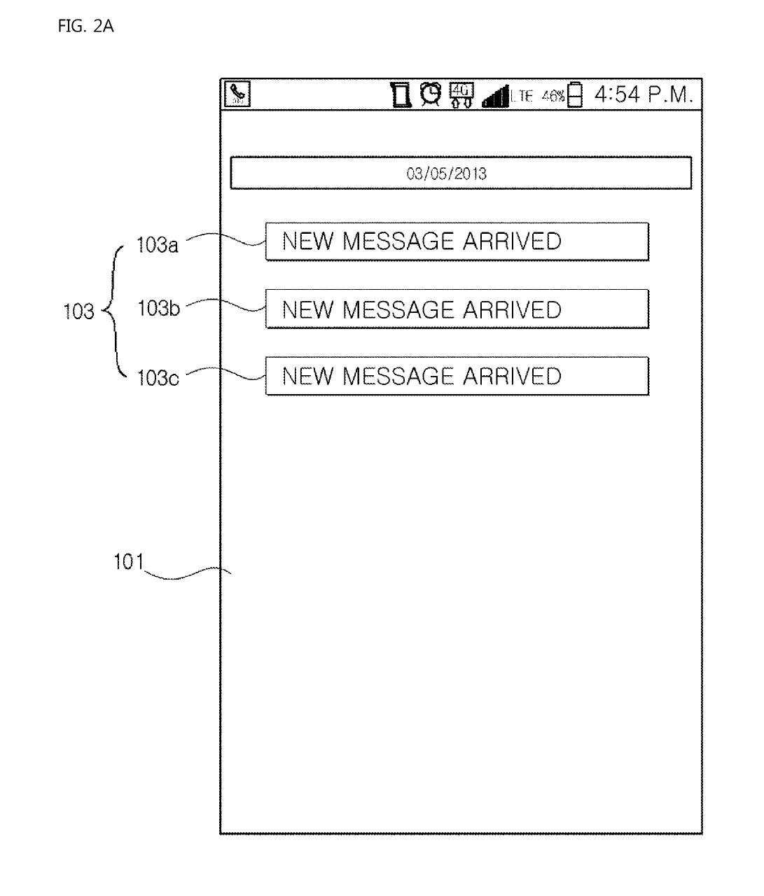

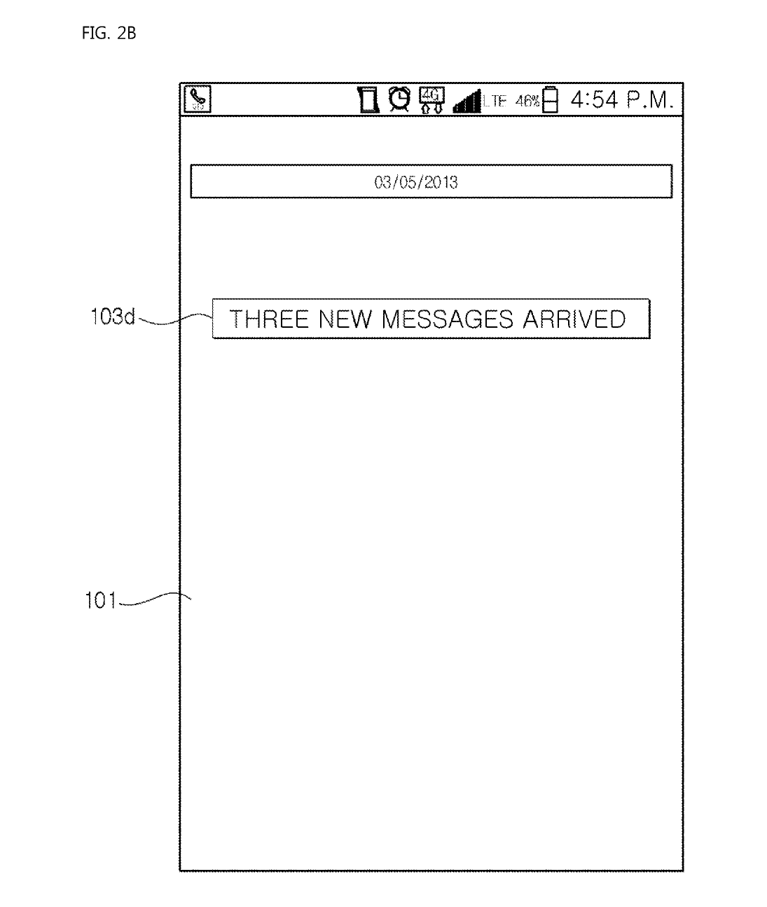

FIGS. 2 to 5 are reference diagrams showing the interface of an application (app) being prepared for commercialization by the present applicant.

A description will be made with reference to FIGS. 2 to 5 together.

First, FIG. 2a illustrates an example of an interface displayed on the recipient terminal 100, and shows an example of an interface displayed on the touch screen 101 of the recipient terminal 50 when the app on the recipient terminal 100 is a non-running state.

Referring to the interface shown in FIG. 2a, reference numeral “103c” denotes a push message sent initially to the recipient terminal 100, reference numeral “103b” denotes a subsequently sent push message, and reference numeral “103a” denotes a most recently received push message.

The contents of respective push messages 103a to 103c may be processed as private information. In this case, on the touch screen 101 of the recipient terminal 100, information about only whether a push message has arrived or not may be displayed with the content of the message being private.

Here, the sender information of the sender terminal 50 that sends a push message to the recipient terminal 100 may be processed as public or private information. Preferably, the sender information may be processed as private information, so that the recipient terminal 100 does not know either the sender of a message or the content of the message, thus further improving the reliability of reading of the push message. At this time, the user of the recipient terminal 100 does not know who sent the received push message, and must manually touch the respective push messages 103a to 103c if he or she is concerned about the sender and the content of the push message. Here, the respective push messages 103a, 103b, and 103c may be sent from different sender terminals.

Next, FIG. 2b illustrates another example of an interface displayed on the recipient terminal 50, and shows an interface in which multiple push messages are packaged into a single message and are then displayed when an app on the recipient terminal 100 is in a non-running state.

Referring to FIG. 2b, a message arrival notification field 103d corresponding to the number of push messages received at the recipient terminal 100 may be displayed on the touch screen 101. This field may be configured such that, when the message arrival notification field 103d is touched by the user, a last push message that arrived (or a first push message initially that arrived at the recipient terminal 100) is displayed on the touch screen 101, and the remaining push messages are waiting for the user's selection, or such that, when the message arrival notification field 103d is touched by the user, a list of push messages that arrived at the recipient terminal 100 is displayed on the touch screen 101. However, the present invention is not limited to such configuration.

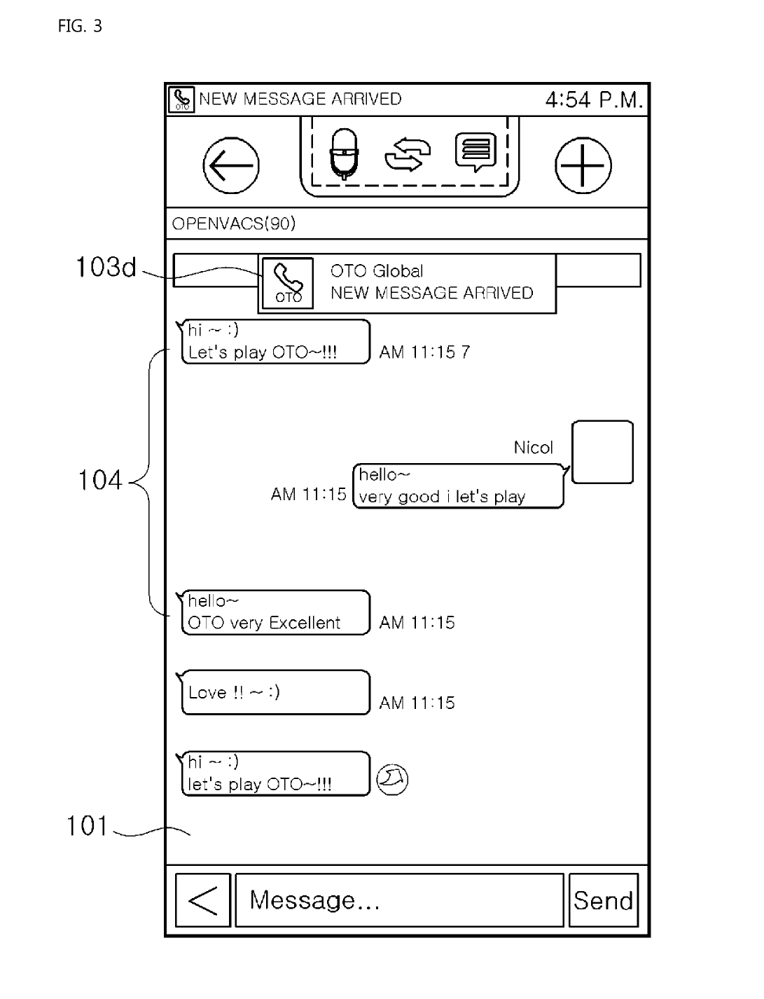

FIG. 3 illustrates an example of an interface for notifying the touch screen 101 of the reception of a push message when the recipient terminal 100 sends and receives instance messages.

Referring to FIG. 3, messages 104 may be displayed on the touch screen 101 of the recipient terminal 100.

A notification message 103d required to provide notification of the arrival of a push message may be displayed in an upper portion of the touch screen 101. When the recipient terminal 100 is chatting with the sender terminal 50, the notification message 103d may be configured to open information about a sender.

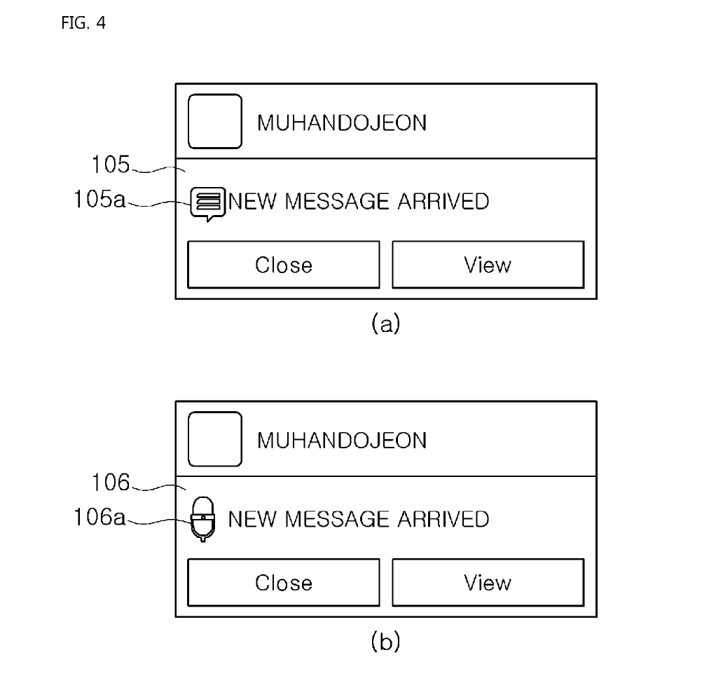

Next, FIG. 4 is a reference diagram showing examples of the expression of message types. FIG. 4(a) illustrates an example of a text type notification message, wherein an icon 105a for indicating that the type of message is a text type may be displayed on the touch screen 101.

FIG. 4 (b) illustrates a notification message 106 indicating that a voice talk file has been received, and an icon 106a for indicating that the type of message is a voice talk file type may be displayed in a portion of the notification message 106 on the touch screen 101.

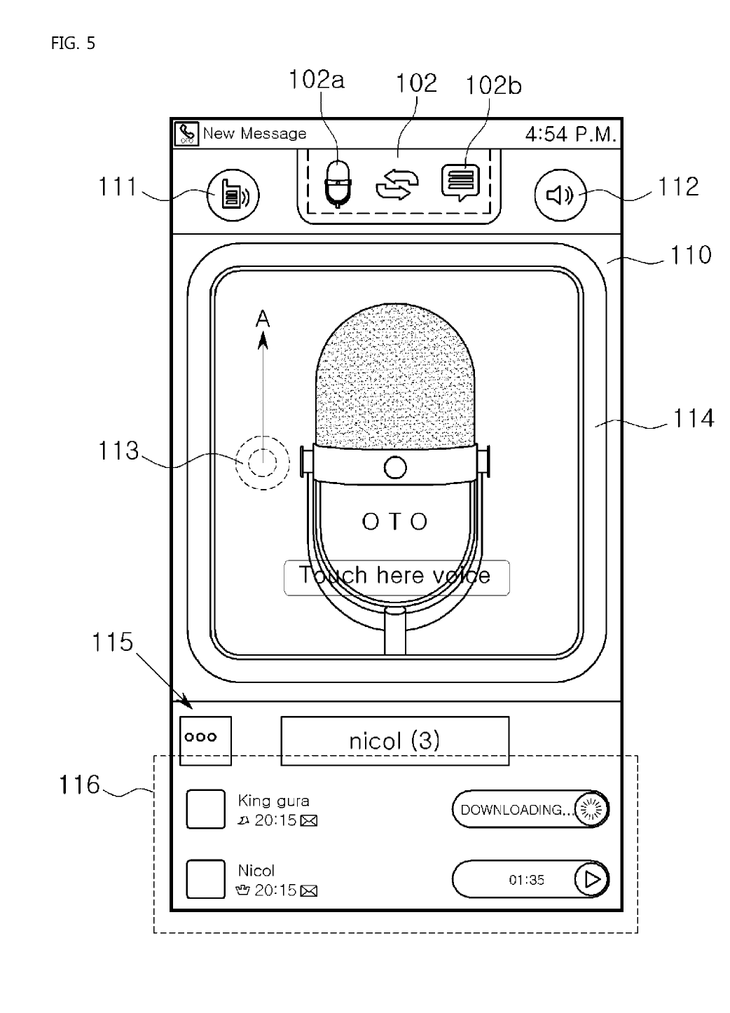

FIG. 5 is a reference diagram showing an example of voice talk.

Voice talk enables voice communication to be alternately performed as in the case of a walkie-talkie by allowing the users of the sender terminal 50 and the recipient terminal 100 to generate voice talk files using their own terminals 50 and 100 and alternately exchange the generated voice talk files with each other. In this case, the sender terminal 50 and the recipient terminal 100 may perform voice communication using a scheme for exchanging files, and may generate voice talk files using the interface shown in FIG. 5.

Referring to FIG. 5, the interface is displayed on the touch screen 101 and may be configured to include a voice input field 114, a speaker on-off menu item 112, a real-time play menu item 111, a mode switching menu item 102, a voice mailbox menu item 116, and a popup menu item 116.

The voice input field 114, which is a menu item occupying the widest area in the touch screen 101, may range from ½ to ¾ of an area in which the touch screen 101 is represented. Alternatively, icons for some menu items may be arranged on one side of the touch screen 101, and the entire area of the touch screen may be set as the voice input field 114. The app is configured such that when the user of the sender's portable terminal 100 touches the voice input field 114, the user's voice is recorded, and such that when the user lifts the touch, the recording of the user' voice is terminated.

Meanwhile, the app may stop the generation of the voice talk file when drag input occurs in the direction of A from a position 121 initially touched by the user in the voice input field 114. When drag input occurs in the direction of A or in the direction diametrically opposite to A, the app may not generate a voice talk file even if the voice input field 114 is touched.

Reference numeral “112” denotes a speaker on-off menu item, which is configured to, when a voice talk file transmitted from the sender terminal 50 to the recipient terminal 100 is played on the recipient terminal 100, set whether or not to play the voice talk file using a speaker or an earphone (or headset) provided on the recipient terminal 100.

Reference numeral “111” denotes to an auto-play menu item that allows the voice talk file transmitted from the sender terminal 50 to the recipient terminal 100 to be automatically played on the recipient terminal 100.

Reference numeral “102” denotes a mode switching menu item required to mutually switch between a voice talk mode and a text message mode, wherein reference numerals “102a” and “102b” indicate respective icons corresponding to the voice talk mode and the text message mode.

Reference numeral “116” denotes a voice mailbox menu item, which is required to display voice talk files that are exchanged by the sender terminal 50 and the recipient terminal 100 with each other. The voice mailbox menu item is registered on the recipient terminal 100, and may be called and played by the user on the recipient terminal 100.

Reference numeral “115” denotes a popup menu item, which is configured such that, when this menu item is touched by the user, a recipient group setting menu item required to set a recipient group with whom the user will talk via voice talk may be displayed on the touch screen 101.

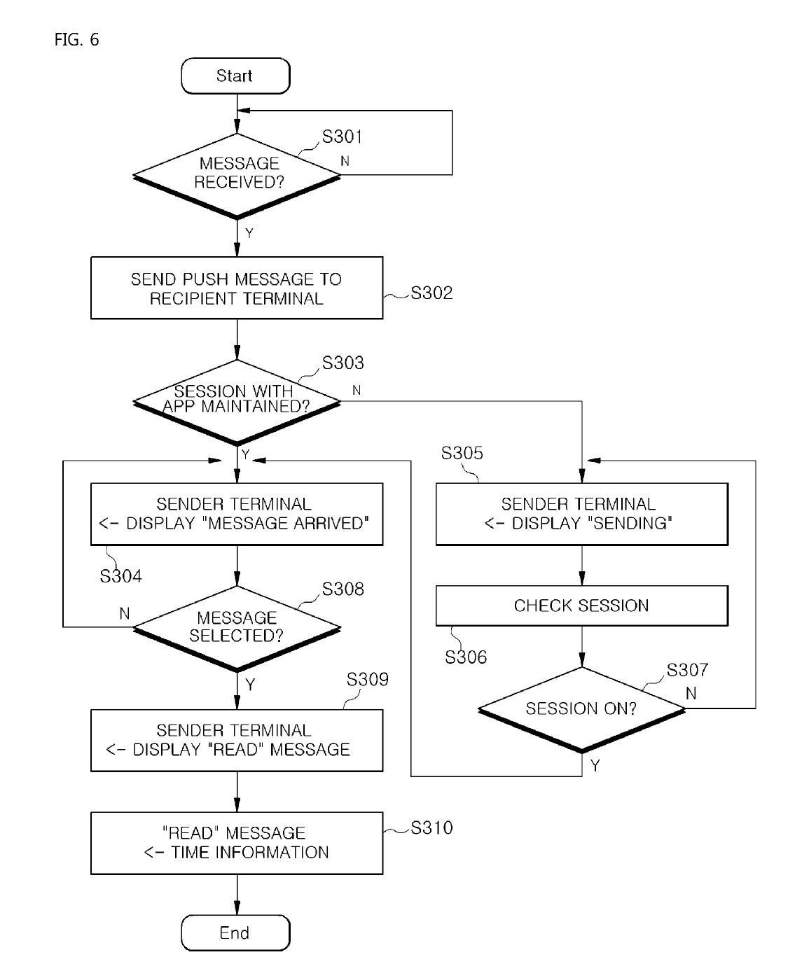

FIG. 6 is a flowchart showing a method for determining the reliability of push messages in a messaging system according to an embodiment of the present invention.

Referring to FIG. 6, the messaging system 200 determines whether a message has been received from the sender terminal 50 at step S301, creates a push message corresponding to a received message if it is determined that the message has been received, and then sends the push message to the recipient terminal 100. Next, the messaging system 200 determines whether a session with the recipient terminal 100 is maintained at step S303. If the session is not maintained, the messaging system 200 provides a control message so that “sending” is displayed on the app interface on the touch screen 101 of the sender terminal 50 at step S305. Thereafter, the messaging system 200 checks the session with the recipient terminal 100 at step S306. If it is determined that the session with the recipient terminal 50 is connected at step S307, the messaging system proceeds to step S304.

Thereafter, if the session with the recipient terminal 50 is maintained, the messaging system 200 provides a control message to the sender terminal 50 so that “message arrived” is displayed at step S308, and determines whether the push message has been read on the recipient terminal 100. Determination of whether the push message has been read is performed by checking whether the app running on the recipient terminal 100 notifies the message system whether the user has read the push message. When the message is selected, the messaging system sends a control message to the sender terminal so that “message read” for the push message is displayed, and allows the user of the sender terminal 50 to determine the time at which the message arrived at the recipient terminal and the time at which the message was read, by adding time information to the control message at step S309.

1. A messaging system for determining reliability of push messages, wherein the messaging system is configured to:
send a push message, corresponding to a message to be sent from a sender terminal to a recipient terminal, to the recipient terminal,
send the push message to the recipient terminal, with content of the push message being private,
determine status of a session with the recipient terminal, and send a control message to the sender terminal so that “message arrived” is displayed as status of the push message if the status of the session is a connected state and the push message has not yet been read on the recipient terminal, and
send a control message to the sender terminal so that “message read” is displayed as the status of the push message if the push message has been read on the recipient terminal.

2. The messaging system of claim 1, wherein the messaging system is configured to send a control message to the sender terminal so that “sending” is displayed as the status of the push message when the status of the session with the recipient terminal is a disconnected state.

3. The messaging system of claim 1, wherein when the recipient terminal sends/receives messages within a chat group identical to that of the sender terminal, information about a sender is provided to the recipient terminal.

4. The messaging system of claim 1, wherein when multiple messages are sent from the sender terminal to the recipient terminal, only pieces of information about whether the multiple messages have arrived at the recipient terminal are provided in a sequence of times at which the respective messages were sent.

5. The messaging system of claim 4, wherein the multiple messages are push messages sent by different senders.

6. The messaging system of claim 1, wherein the push message is a message corresponding to at least one of text, a picture, an image, and voice.

7. The messaging system of claim 1, wherein the push message is a voice talk file in which voice of a user of the sender terminal is recorded.

8. The messaging system of claim 1, wherein the control message comprises time information for each state of the message.

9. The messaging system of claim 8, wherein the time information comprises time information about a time at which the push message arrived at the recipient terminal and a time at which the push message was read on the recipient terminal.

10. The messaging system of claim 1, wherein the push message is a message in which information about the sender is private.

11. The messaging system of claim 1, wherein the push message is a message in which information about the sender is public.

12. The messaging system of claim 11, wherein the sender information is any one of a name, a contact, an ID, and a nickname of the sender.
